(19) United States
(12) Patent Application Publication
(10) Pub. No.: US 2010/0021786 A1
(43) Pub. Date: Jan. 28, 2010

(54) FUEL CELL

(76) Inventor: Satoshi Aoyama, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/439,243

(22) PCT Filed: Aug. 31, 2007
(86) PCT No.: PCT/JP2007/067459

§ 371 Date: Feb. 27, 2009

(30) Foreign Application Priority Data
Sep. 5, 2006 (JP) 2006-239896

(51) Int. Cl. H01M 8/10; H01M 4/92; H01M 4/94

(52) U.S. Cl. 429/30

(57) ABSTRACT

A fuel cell includes a hydrogen permeable metal substrate and an electrolyte layer. The hydrogen permeable metal substrate acts as an anode. The electrolyte layer is provided on the hydrogen permeable metal substrate and has proton conductivity. At least a part of the hydrogen permeable metal substrate is composed of a metal having a recrystallization temperature higher than a given temperature.

### TECHNICAL FIELD

This invention generally relates to a fuel cell.

### BACKGROUND ART

In general, a fuel cell is a device that obtains electrical power from fuel, hydrogen and oxygen. Fuel cells are being widely developed as an energy supply device because fuel cells are environmentally superior and can achieve high energy efficiency.

There are some types of fuel cells including a solid electrolyte such as a polymer electrolyte fuel cell, a solid-oxide fuel cell, and a hydrogen permeable membrane fuel cell (HMFC). Here, the hydrogen permeable membrane fuel cell has a dense hydrogen permeable membrane. The dense hydrogen permeable membrane is composed of a metal having hydrogen permeability, and acts as an anode. The hydrogen permeable membrane fuel cell has a structure in which an electrolyte having proton conductivity is deposited on the hydrogen permeable membrane. Some hydrogen provided to the hydrogen permeable membrane is converted into protons with catalyst reaction. The protons are conducted in the electrolyte having proton conductivity, react with oxygen provided at a cathode, and electrical power is thus generated, as disclosed in Patent Document 1.

### Patent Document 1: Japanese Patent Application Publication No. 2004-146337

### Disclosure of the Invention

With the art disclosed in Patent Document 1, however, there is a case where the hydrogen permeable membrane is interfacially separated from the electrolyte layer because of a deformation of the hydrogen permeable membrane during the operation of the hydrogen permeable membrane fuel cell.

An object of the present invention is to provide a fuel cell in which an interfacial separation is restrained between the hydrogen permeable membrane and the electrolyte layer.

The fuel cell in accordance with the present invention includes a hydrogen permeable metal substrate and an electrolyte layer. The hydrogen permeable metal substrate acts as an anode. The electrolyte layer is provided on the hydrogen permeable metal substrate and has proton conductivity. At least a part of the hydrogen permeable metal substrate is composed of a metal having a recrystallization temperature higher than a given temperature.

With the fuel cell in accordance with the present invention, deformation of the hydrogen permeable metal substrate is restrained even if the temperature of the fuel cell is increased, because the recrystallization temperature of the hydrogen permeable metal substrate is higher than the given temperature. This results in that a separation is restrained between the hydrogen permeable metal substrate and the electrolyte layer. Alternatively, a crack is restrained in the electrolyte layer.

The given temperature may be a recrystallization temperature of pure palladium. In this case, the deformation of the hydrogen permeable metal substrate is more restrained than a case where the pure palladium is used as the hydrogen permeable metal substrate. The given temperature may be a maximum of an operation temperature of the fuel cell. In this case, the deformation of the fuel cell is restrained in the operation of the fuel cell.

The given temperature may be the highest temperature to which the hydrogen permeable metal substrate is subjected with the hydrogen permeable metal substrate contacting with the electrolyte layer, in a manufacturing process and an operation process of the fuel cell. In this case, the deformation of the hydrogen permeable metal substrate is restrained in the manufacturing process and the operation process of the fuel cell. The electrolyte layer may be formed with a coating method, and the given temperature may be a coating temperature of the electrolyte layer. In this case, the deformation of the hydrogen permeable metal substrate is restrained when the electrolyte layer is formed.

The metal having the recrystallization temperature higher than the given temperature may be a noble metal. In this case, a separation caused by an oxidation of the hydrogen permeable metal substrate is restrained. The given temperature may be 550 degrees C.

A hydrogen swell coefficient of the metal having the recrystallization temperature higher than the given temperature may be less than a given value. In this case, the deformation of the hydrogen permeable metal substrate is restrained even if the hydrogen permeable metal substrate is exposed to hydrogen atmosphere. The metal having the recrystallization temperature higher than the given temperature may be Pd alloy, and the given value may be a hydrogen swell coefficient of pure Pd. In this case, the deformation of the hydrogen permeable metal substrate is more restrained than a case where the pure palladium is used as the hydrogen permeable metal substrate.

The metal having the recrystallization temperature higher than the given temperature may be PdPt-based alloy or PdAuRh-based alloy. The metal having the recrystallization temperature higher than the given temperature may be provided at least on a surface of the hydrogen permeable metal substrate at the electrolyte layer side. In this case, the deformation of a surface of the hydrogen permeable metal substrate at the electrolyte layer side is restrained. The separation is restrained effectively between the hydrogen permeable metal substrate and the electrolyte layer.

### Effects of the Invention

According to the present invention, interfacial separation between the hydrogen permeable metal substrate and the electrolyte layer is restrained.

### BRIEF DESCRIPTION OF THE DRAWINGS

FIG. 1 illustrates a schematic cross sectional view of a fuel cell in accordance with an embodiment of the present invention;

FIG. 2 illustrates a relationship between a recrystallization temperature and an amount of leaking hydrogen of a hydrogen permeable metal substrate; and

FIG. 3 illustrates a relationship between a hydrogen swell coefficient and an amount of leaking hydrogen of a hydrogen permeable metal substrate.

### BEST MODES FOR CARRYING OUT THE INVENTION

A description will now be given of best modes for carrying out the present invention.

### EMBODIMENTS

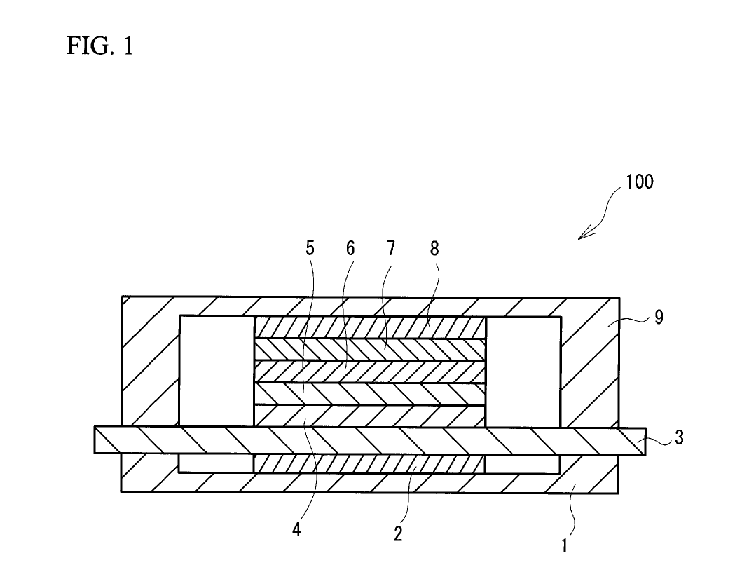

FIG. 1 illustrates a schematic cross sectional view of a fuel cell 100 in accordance with an embodiment of the present invention. In this embodiment, a hydrogen permeable membrane fuel cell is used as a fuel cell. As shown in FIG. 1, the fuel cell 100 has separators 1 and 9, power collectors 2 and 8, a strengthening substrate 3, a hydrogen permeable metal substrate 4, an intermediate layer 5, an electrolyte layer 6 and a cathode 7. In the embodiment, a description is given of a unit fuel cell shown in FIG. 1 for simplification. In an actual fuel cell, a plurality of the unit fuel cells may be stacked.

The separator 1 is composed of a conductive material such as stainless steal. And a convex portion is formed at a peripheral area on an upper face of the separator 1. The power collector 2 is, for example, composed of a conductive material such as a sintered foamed porous metal, a SUS430 porous material, a Ni porous material, a Pt-coated Al₂O₃ porous material, or a Pt mesh. The power collector 2 is laminated on a center area of the separator 1.

The strengthening substrate 3 is composed of a conductive material such as stainless steel and strengthens the hydrogen permeable metal substrate 4 and the electrolyte layer 6. The strengthening substrate 3 is provided on the separator 1 through the convex portion of the separator 1 and the power collector 2. The strengthening substrate 3 is jointed to the separator 1 with a brazing material or the like. A plurality of through holes (not shown) is formed at the center portion of the strengthening substrate 3. This results in that fuel gas is provided to the hydrogen permeable metal substrate 4 from the power collector 2.

The hydrogen permeable metal substrate 4 is laminated on the strengthening substrate 3 so as to cover the through holes formed in the strengthening substrate 3. The hydrogen permeable metal substrate 4 acts as an anode to which the fuel gas is provided and strengthens the electrolyte layer 6. The hydrogen permeable metal substrate 4 has hydrogen permeability and is composed of a metal having recrystallization temperature higher than a given temperature. A detail description of the hydrogen permeable metal substrate 4 is described later. Thickness of the hydrogen permeable metal substrate 4 is, for example, 5 μm to 100 μm.

The intermediate layer 5 is laminated on the hydrogen permeable metal substrate 4. The intermediate layer 5 absorbs the interfacial separation between the hydrogen permeable metal substrate 4 and the electrolyte layer 6. That is, the intermediate layer 5 is composed of a material having higher adhesiveness to the hydrogen permeable metal substrate 4 than the electrolyte layer 6 and higher adhesiveness to the electrolyte layer 6 than the hydrogen permeable metal substrate 4. It is preferable that the intermediate layer 5 dissociates hydrogen, because conversion of hydrogen into protons is promoted. For example, it is possible to use pure palladium as the intermediate layer 5 dissociating hydrogen. The intermediate layer 5 may be composed of a material not having hydrogen permeability. There is little influence on the hydrogen permeability if the thickness of the intermediate layer 5 is reduced. The thickness of the intermediate layer 5 is, for example, 10 nm to 500 nm.

The electrolyte layer 6 is formed on the intermediate layer 5. The electrolyte layer 6 is composed of a material having proton conductivity. A solid oxide electrolyte such as perovskite may be used as the electrolyte layer 6. The thickness of the electrolyte layer 6 is, for example, 0.2 μm to 5 μm. A coating method of the electrolyte layer 6 is not limited. The method may be a PLD method. The cathode 7 is, for example, composed of a conductive material such as lanthanum cobaltite, lanthanum manganate, silver, platinum, or platinum-supported carbon, and is laminated on the electrolyte layer 6. The cathode 7 may be formed with a screen-printing method.

The power collector 8 is composed of a material as same as that of the power collector 2, and is laminated on the cathode 7. The separator 9 is composed of a material as same as that of the separator 1, and is laminated on the power collector 8. And a convex portion is formed at a peripheral area of a lower face of the separator 9. The separator 9 is jointed to the strengthening substrate 3 through the convex portion of the separator 9. Insulation is performed between the strengthening substrate 3 and the separator 9. This results in that an electrical short is restrained between the separator 1 and the separator 9.

Next, a description will be given of an operation of the fuel cell 100. A fuel gas including hydrogen is provided to the power collector 2. This fuel gas is provided to the hydrogen permeable metal substrate 4 via the power collector 2 and the through hole of the strengthening substrate 3. Some hydrogen in the fuel gas is converted into protons at the hydrogen permeable metal substrate 4. The protons are conducted in the hydrogen permeable metal substrate 4 and the electrolyte layer 6, and get to the cathode 7.

On the other hand, an oxidant gas including oxygen is provided to the power collector 8. This oxidant gas is provided to the cathode 7. The protons react with oxygen in the oxidant gas provided to the cathode 7. Water and electrical power are thus generated. The generated electrical power is collected via the power collectors 2 and 8 and the separators 1 and 9.

Heat is generated when the electrical power is generated. And a temperature of the fuel cell 100 is increased during the electrical power generation. In the embodiment, a deformation of the hydrogen permeable metal substrate 4 is restrained even if the temperature of the fuel cell 100 is increased, because the metal composing the hydrogen permeable metal substrate 4 has a recrystallization temperature higher than a given temperature. The separation is therefore restrained between the hydrogen permeable metal substrate 4 and the electrolyte layer 6. Alternatively, a crack is restrained in the electrolyte layer 6.

It is preferable that the recrystallization temperature of the metal composing the hydrogen permeable metal substrate 4 is higher than that of pure palladium, because the deformation of the hydrogen permeable metal substrate 4 is more restrained than a case where the hydrogen permeable metal substrate 4 is composed of pure palladium. It is preferable that the recrystallization temperature of the metal composing the hydrogen permeable metal substrate 4 is higher than a maximum of an operation temperature of the fuel cell 100, because the deformation of the hydrogen permeable metal substrate 4 is restrained during the operation of the fuel cell 100. The maximum of the operation temperature of the fuel cell 100 is, for example, 400 degrees C. to 600 degrees C.

It is preferable that the recrystallization temperature of the metal composing the hydrogen permeable metal substrate 4 is higher than a formation temperature of the electrolyte layer 6, because the deformation of the hydrogen permeable metal substrate 4 is restrained during the formation of the electrolyte layer 6. The formation temperature of the electrolyte layer 6 depends on the material composing the electrolyte layer 6. The formation temperature is, for example, 600 degrees C. The formation temperature is a temperature of the electrolyte layer 6 during the formation thereof.

It is preferable that the recrystallization temperature of the metal composing the hydrogen permeable metal substrate 4 is higher than a melting temperature of a brazing material during a jointing process between the strengthening substrate 3 and the separators 1 and 9. The melting temperature of the brazing material depends on a kind of the brazing material, and is for example 500 degrees C. to 600 degrees C.

It is preferable that the recrystallization temperature of the metal composing the hydrogen permeable metal substrate 4 is higher than a maximum temperature to which the hydrogen permeable metal substrate 4 is subjected with the electrolyte layer 6 being formed on the hydrogen permeable metal substrate 4, in the manufacturing process of the fuel cell 100 and the operation process of the fuel cell 100. In this case, the separation between the hydrogen permeable metal substrate 4 and the electrolyte layer 6 is restrained in the manufacturing process and the operation process of the fuel cell 100. It is preferable that the recrystallization temperature of the metal composing the hydrogen permeable metal substrate 4 is higher than the formation temperature of the intermediate layer 5, if the formation temperature of the intermediate layer 5 is the highest.

Here, Table 1 shows materials to be used as the hydrogen permeable metal substrate 4. The recrystallization temperature in Table 1 is a temperature when the hardness of an objective metal layer having a thickness of 0.1 mm is center before and after softening in a case where the metal layer is subjected to a heat treatment and the hardness variation of the metal layer is measured. The heat treatment is performed two hours in a vacuum atmosphere and at a given temperature range. It is, in particular, preferable that PdPt-based alloy or PdAuRh-based alloy in the metals shown in Table 1 is used. It is possible to restrain a separation caused by an oxidation of the hydrogen permeable metal substrate 4 if the noble metal alloys shown in Table 1 are used as the hydrogen permeable metal substrate 4.

TABLE 1

| | RECRYSTALLIZATION TEMPERATURE |
|---|---|
| METAL | (DEGREES C.) |
| PURE Pd | 250 |
| PdAg23 | 450 |
| PdPt8.8 | 450 |
| PdPt16.9 | 550 |
| PdAu25Rh5 | 650 |
| PdAU31.6 | 550 |
| PdRu5 | 800 |

It is preferable that a hydrogen swell coefficient of the metal composing the hydrogen permeable metal substrate 4 is less than a given value, because the deformation of the hydrogen permeable metal substrate 4 is restrained even if the hydrogen permeable metal substrate 4 is exposed to hydrogen atmosphere. It is preferable that the hydrogen swell coefficient of the metal composing the hydrogen permeable metal substrate 4 is less than that of pure palladium, because the deformation of the hydrogen permeable metal substrate 4 is more restrained than a case where the pure palladium is used as the hydrogen permeable metal substrate 4.

The effect of the present invention is obtained when the metal having the recrystallization temperature higher than the given temperature (hereinafter referred to as recrystallization-resistant metal) is included in the hydrogen permeable metal substrate 4. The recrystallization-resistant metal may be formed to be a layer in the hydrogen permeable metal substrate 4. In this case, it is preferable that the recrystallization-resistant metal forms the thickest layer in the hydrogen permeable metal substrate 4, because the deformation of the hydrogen permeable metal substrate 4 is restrained totally. It is preferable that the recrystallization-resistant metal is at least formed on the surface of the hydrogen permeable metal substrate 4 at the electrolyte layer 6 side. In this case, it is possible to restrain the separation between the hydrogen permeable metal substrate 4 and the electrolyte layer 6 effectively because the deformation of the hydrogen permeable metal substrate 4 is restrained at the electrolyte layer 6 side.

### EXAMPLES

The fuel cell 100 had been manufactured according to the embodiment, and the separation between the hydrogen permeable metal substrate 4 and the electrolyte layer 6 had been investigated.

### Example 1

In Example 1, PdAu25Rh5 alloy having a thickness of 80 μm had been used as the hydrogen permeable metal substrate 4. Pure palladium having a thickness of 50 nm had been used as the intermediate layer 5. SrZr_{0.8}In_{0.2}O₃ having a thickness of 2 μm had been used as the electrolyte layer 6. The formation temperature of the intermediate layer 5 had been 600 degrees C. The formation temperature of the electrolyte layer 6 had been 600 degrees C. A jointing temperature between the separators 1 and 9 and the strengthening substrate 3 had been 600 degrees C.

### Example 2

In Example 2, PdPt16.9 alloy having a thickness of 80 μm had been used as the hydrogen permeable metal substrate 4. The other structure of the fuel cell 100 in accordance with Example 2 is the same as that in accordance with Example 1.

### Comparative Example

In Comparative example, pure Pd having a thickness of 80 μm had been used as the hydrogen permeable metal substrate 4. The intermediate layer 5 had not been provided. The other structure of the fuel cell 100 in accordance with Comparative example is the same as that in accordance with Example 1.

### (Analysis)

Hydrogen gas had been provided to the anode and air had been provided to the cathode, and each of the fuel cells had generated electrical power for 25 hours. The voltage during the electrical power generation of each fuel cell had been set to be 0.7 V. The operation temperature during the electrical power generation had been set to be 400 degrees C. Then, hydrogen gas had been provided to the anode, nitrogen gas had been provided to the cathode, and hydrogen concentration in the gas at the cathode side had been measured with gaschromatograph. The results are shown in Table 2. As shown in Table 2, interfacial separation had been observed between the hydrogen permeable metal substrate 4 and the electrolyte layer 6 in the fuel cell in accordance with Comparative example. However, the interfacial separation had not been observed in the fuel cells in accordance with Examples 1 and 2.

TABLE 2

| | | RECRYSTALLIZATION | HYDROGEN | | | |
|---|---|---|---|---|---|---|
| | | TEMPERATURE | SWELL | | H₂ LEAKING | SEPARATION- |
| | ALLOY | (DEGREES C.) | (Pd = 100) | SEPARATION | (ppm) | RESISTANT |
| EXAMPLE 1 | PdAu25Rh5 | 650 | 75 | NOT | FEW TENS | ⊚ |
| EXAMPLE 2 | PdPt16.9 | 550 | 50 | SEPARATED | FEW HUNDREDS | ◯ |
| COMPARATIVE | PURE Pd | 250 | 100 | A LITTLE | FEW THOUSANDS | Δ |
| EXAMPLE | | | | | | |

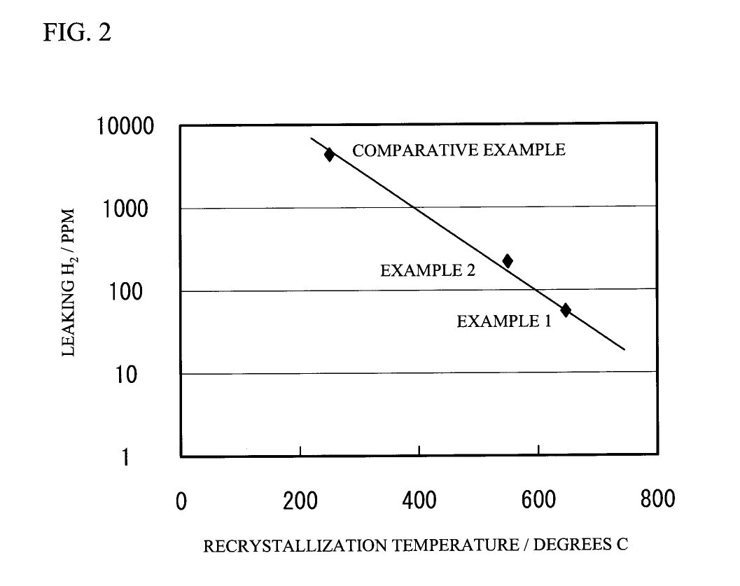

FIG. 2 illustrates a relationship between the recrystallization temperature of the hydrogen permeable metal substrate 4 and an amount of leaking hydrogen (hydrogen concentration). A horizontal axis of FIG. 2 indicates the recrystallization temperature of the hydrogen permeable metal substrate 4. A vertical axis of FIG. 2 indicates the amount of the leaking hydrogen. As shown in FIG. 2, the amount of leaking hydrogen gets reduced as the recrystallization temperature is increased. It is therefore confirmed that the separation between the hydrogen permeable metal substrate 4 and the electrolyte layer 6 is restrained effectively when a metal having a high recrystallization temperature is used as the hydrogen permeable metal substrate 4.

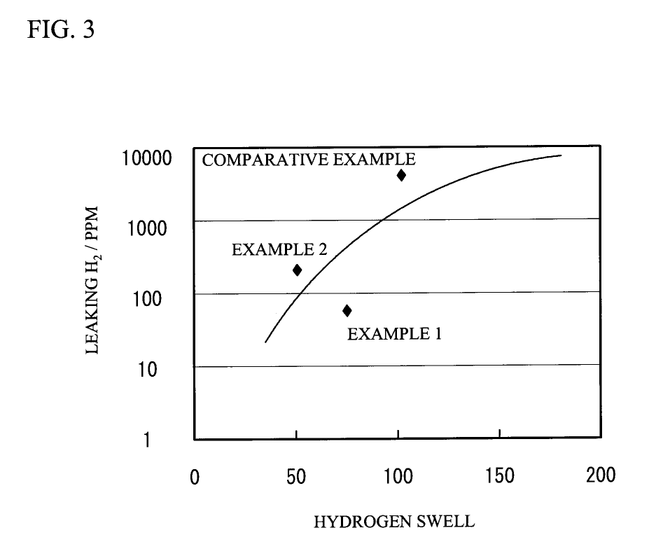

FIG. 3 illustrates a relationship between the hydrogen swell coefficient of the hydrogen permeable metal substrate 4 and the amount of leaking hydrogen (hydrogen concentration). A horizontal axis of FIG. 3 indicates the hydrogen swell coefficient of the hydrogen permeable metal substrate 4. A vertical axis of FIG. 3 indicates the amount of the leaking hydrogen. As shown in FIG. 3, the amount of leaking hydrogen gets reduced as the hydrogen swell coefficient is reduced. It is therefore confirmed that the separation between the hydrogen permeable metal substrate 4 and the electrolyte layer 6 is restrained more effectively when a metal having a high recrystallization temperature and having a low hydrogen swell coefficient is used as the hydrogen permeable metal substrate 4.

1. A fuel cell comprising:
a hydrogen permeable metal substrate that acts as an anode; and
a solid electrolyte layer that is provided on the hydrogen permeable metal substrate and has proton conductivity,
wherein at least a part of the hydrogen permeable metal substrate is composed of a metal having a recrystallization temperature higher than that of pure palladium.

2. (canceled)

3. The fuel cell as claimed in claim 1, wherein the recrystallization temperature of the metal composing the hydrogen permeable metal substrate is higher than a maximum of an operation temperature of the fuel cell.

4. The fuel cell as claimed in claim 1, wherein the recrystallization temperature of the metal composing the hydrogen permeable metal substrate is higher than the highest temperature to which the hydrogen permeable metal substrate is subjected with the hydrogen permeable metal substrate contacting with the electrolyte layer, in a manufacturing process and an operation process of the fuel cell.

5. The fuel cell as claimed in claim 1, wherein:
the electrolyte layer is formed with a coating method; and
the recrystallization temperature of the metal composing the hydrogen permeable metal substrate is higher than a formation temperature of the electrolyte layer.

6. The fuel cell as claimed in claim 1, wherein the metal having the recrystallization temperature higher than that of pure palladium is a noble metal.

7. The fuel cell as claimed in claim 1, wherein the recrystallization temperature of the metal composing the hydrogen permeable metal substrate is higher than 550 degrees C.

8. The fuel cell as claimed in claim 1, wherein a hydrogen swell coefficient of the metal having the recrystallization temperature higher than that of pure palladium is less than a given value.

9. The fuel cell as claimed in claim 8, wherein:
the metal having the recrystallization temperature higher than that of pure palladium is Pd alloy; and
the given value is a hydrogen swell coefficient of pure Pd.

10. The fuel cell as claimed in claim 1, wherein the metal having the recrystallization temperature higher than that of pure palladium is PdPt-based alloy or PdAuRh-based alloy.

11. The fuel cell as claimed in claim 1, wherein the metal having the recrystallization temperature higher than that of pure palladium is provided at least on a surface of the hydrogen permeable metal substrate at the electrolyte layer side.
